(19) United States
(12) Patent Application Publication
(10) Pub. No.: US 2020/0171762 A1
(43) Pub. Date: Jun. 4, 2020

(54) METHOD FOR PRODUCING A FIBER-REINFORCED PLASTIC COMPONENT

(71) Applicant: VOLKSWAGEN AKTIENGESELLSCHAFT, Wolfsburg (DE)

(72) Inventors: ALINE KUBISCH, WOLFSBURG (DE); MAX EHLEBEN, BRAUNSCHWEIG (DE); THOMAS MERTENS, EHRA-LESSIEN (DE); FABIAN FISCHER, HANNOVER (DE); MAURICE BITTERLICH, LEHRE (DE); PHILIPPE DESBOIS, EDINGEN (DE)

(21) Appl. No.: 16/326,506

(22) PCT Filed: Aug. 4, 2017
(86) PCT No.: PCT/EP2017/069778

§ 371 Date: Feb. 19, 2019

(30) Foreign Application Priority Data
Aug. 18, 2016 (DE) 10 2016 009 907.0

(51) Int. Cl. B29C 70/34; B29C 70/08; B32B 37/18; B32B 5/02

(52) U.S. Cl. CPC B29C 70/345; B32B 5/02; B32B 37/18; B29C 70/081

(57) ABSTRACT

A method for producing a fiber-reinforced plastic component includes providing an at least two or more-layered textile structure made of a carrier layer onto which a short-fiber layer, in which short fibers are saturated with a not yet polymerized starting component of a reactive thermoplastic matrix material, is applied, making up or producing the textile structure into a fiber-reinforced textile semi-finished fiber product, and pressing/deep drawing the fiber-reinforced textile semi-finished fiber product into a mold for the fiber-reinforced plastic component to be produced, while at the same time heating the fiber-reinforced textile semi-finished fiber product to a temperature above the polymerization starting temperature. A process arrangement for producing a fiber-reinforced plastic component and a fiber-reinforced plastic component are also provided.

The invention relates to a method for producing a fiber-reinforced plastic component according to the preamble to patent claim 1, a process arrangement for producing the fiber-reinforced plastic component as claimed in patent claim 14, and a fiber-reinforced plastic component as claimed in patent claim 15.

The conventional production of a fiber-reinforced thermoplastic plastic component currently takes place with an organic sheet or from tape-laid, two-dimensional panels, which are heated above the thermoplastic melting temperature in a heating section and are subsequently formed in a press tool. The plastic component produced in this way is capable, in addition, of being injection back-molded in an injection molding tool with local force transmission structures, for example ribs and/or metal inserts, to be precise with a conventional short fiber reinforced thermoplastic.

A generic method for producing reactive prepregs, that is to say endless fiber reinforced, two-dimensional semi-finished products, with a polyamide matrix is known from WO 2012/116947 A1. In the process, textile structures with a liquid starting component of the polyamide matrix, that is to say molten lactam including added catalysts and/or activators, are pre-impregnated to be precise in a continuous process. The pre-impregnated textile endless structure is then made up into fiber reinforced, two-dimensional semi-finished products in a making-up station, and these are stacked one on top of the other in a stacking station. During further processing, the fiber semi-finished products are loaded in a tool cavity of a press tool and/or a deep drawing tool, in which the molding takes place, and, to be precise, at a temperature above the polymerization starting temperature. The pre-impregnated lactam polymerizes into a polyamide in this way. The fiber reinforced, two-dimensional semi-finished product is brought into the intended form of the plastic component to be manufactured by concurrent deep drawing/pressing.

A fiber reinforced polyurethane molded component is known from WO 2011/023322 A1, which exhibits force transmission structures, for example ribs, webs or domes, which are fiber reinforced. A method for producing composite material components, which are constructed from plastic and are produced by high-pressure resin transfer molding, is known from DE 10 2012 110 307 A1. A further method for producing fiber reinforced, flat semi-finished products with a polyamide matrix is known from EP 2 681 038 B1. A method for producing a fiber composite component, which is produced from long fibers and short fibers, is known from DE 10 2013 210 934 A1.

The object of the invention is to make available a method and a process arrangement for producing a fiber reinforced plastic component, as well as such a plastic component in which the functionality and the possible applications of the fiber reinforced plastic component are broadened.

The object is accomplished by the characterizing features of patent claim 1, 14 or 15. Preferred refinements of the invention are disclosed in the dependent claims.

According to the invention, in the method known from WO 2012/116947 A1, at least one two-layer or multi-layer textile structure comprising a support layer and a short fiber layer is made available, which is applied to the support layer. In the short fiber layer, the short fibers are saturated with an as yet not polymerized, reactive thermoplastic starting component of a matrix material, that is to say a reactive monomer solution made of lactam, for example.

The application of the short fibers can be performed manually, for example, by sprinkling or strewing. This results in a two-layer prepreg, which can subsequently be made up and further processed by analogy with the method in WO 2012/116947 A1. The use of short fibers with a fiber length of 0.05 to 50 mm is preferable in this case, wherein shorter fiber lengths in the region of 0.1 to 1.0 mm are especially preferred. The proportion of short fibers preferably lies in a range from 10 to 40% by weight.

The application and the saturation of the fibers with the matrix material starting component can take place in different ways. According to a first variant embodiment, the fresh short fibers, that is to say the short fibers in the dry state, are cut from endless fiber rovings directly in the production facility with the help of a cutting tool, to be precise immediately ahead of the application of the fibers and the matrix material components respectively. As an alternative thereto, fresh short fiber material can be bought in and applied or admixed directly with the matrix material starting components.

The support layer can preferably be a fiber structure having at least one endless fiber layer, which is saturated with the molten, reactive monomer solution (that is to say the reactive, thermoplastic starting component of the matrix material), in an impregnation step. As an alternative thereto, however, it is also possible to dispense with an endless fiber reinforced material in the support layer. A film or nonwoven material, etc., can be used instead, to which the short fibers are applied and are then saturated.

The application of the short fibers to the support layer can take place in different ways. Thus, in a first process sequence, the short fibers can be applied in the dry state to the still dry support layer before a subsequent impregnation step. The impregnation step then takes place, in which both the support layer and the short fibers are saturated with the reactive monomer solution.

As an alternative thereto, the dry short fibers can be applied to the already impregnated support layer. The still dry short fibers must then be saturated with a reactive monomer solution in a separate, second impregnation step, so that in total a first impregnation layer (for impregnation of the support layer) and a second impregnation step (for impregnation of the short fibers) take place. In this case, the viscosity of the first and second impregnation can vary in order, for example, to achieve a better fiber entrainment in the following pressing operation. An additional, second metering unit for impregnating the short fibers is required in this case. The above-mentioned second impregnation step (for impregnating the short fibers) is dispensed with in a simpler variant from the point of view of process engineering. Instead of this, any surplus material from the matrix material of the support layer is used as the matrix material for the applied short fibers.

In a further, alternative process step, the dry short fibers can be mixed with the liquid, reactive monomer solution in a metering unit. The reactive monomer solution is then applied, together with the short fibers contained therein, to the still dry support layer in an impregnation step. In this case, the saturation of the support layer and the application of the short fibers to the support layer take place concurrently. As an alternative thereto, the support layer can be saturated with a short fiber-free, reactive monomer solution in a first impregnation step. An application process step can then take place, in which a reactive monomer solution with admixed short fibers can be applied to the support layer.

In a further embodiment, by forming a sandwich structure, a third fiber layer can be applied to the short fiber layer. This layer can consist of an additional textile structure, for example a woven fabric, a nonwoven fabric or a laid fabric. Furthermore, there is the possibility of foaming the resulting middle short fiber layer. Suchlike foaming can be facilitated via a metering unit by physical or chemical foaming, for example by foamable, short fiber-free films, or by a foamable matric material (with short fibers).

Furthermore, a laminating film which protects the prepreg can be applied regardless of the number of additionally applied layers of short fiber and endless fiber reinforced material on the bottom and top covering layer. As an extension thereto, components with a visible side can also be produced, in which a film having a surface function in addition to the protective function is used on the one side. As an alternative, the film can also be retained as a protective film, and an additional nonwoven material can be introduced underneath the protective film as a surface finish. It is also possible, in addition thereto, to separate the foil on one or both sides before the final trimming cut of the saturated fiber structure. In this case, however, the prepregs must be protected, in particular against the ingress of airborne humidity, up to the point of production of finished components.

As already mentioned above, the inventive method is implemented in line with WO 2012/116947 A1, albeit differing with regard to the achievable plastic component geometries. For the production of plastic components, the at least two-layer or multi-layer fiber reinforced textile fiber semi-finished product is loaded into the tool cavity of a heated press tool and is formed into the plastic component in the pressing operation. The temperature of the heated tool mold in this case preferably lies in the range from 140 to 160° C., that is to say necessarily above the polymerization starting temperature. The hardened monomer solution (known as lactam) melts during the pressing operation and, as a result, becomes free-flowing and is subsequently able to polymerize.

The fiber reinforced plastic component produced according to the invention can preferably exhibit a short fiber-reinforced force transmission structure protruding therefrom. In this case, a negative mold for this force transmission structure is reproduced in a tool half of the press tool. The fiber semi-finished product is thus loaded into the tool cavity so that its short fiber layer faces towards the negative mold for the force transmission structure reproduced in the tool half. In addition, it is preferable if the tool half lies at the top when viewed in a vertical direction of the tool, so that the heated, molten matrix material starting component is pressed upwards into the negative mold for the force transmission structure of the top tool half. A clearly better adhesion strength of the force transmission structure is achieved by pressing the force transmission structure upwards from the basic surface of the prepreg, to be precise by comparison with a negative mold for the force transmission structure configured in the bottom tool half. In this case, the negative mold would be filled as a result of the generally very free-flowing matrix material starting components flowing by gravity and already being able to polymerize there. In this case, however, there is no guarantee that an adequate connection has been produced with the overlying prepreg at the starting point for polymerization. This can lead to reduced adhesion strengths of the force transmission structure.

In addition, an insert can be integrated into the force transmission structure before implementing the pressing operation. It is useful for this purpose to insert the utilized inserts, for example threaded bushes, threaded bolts, etc., into the pressing tool before the pressing operation and to hold them in the desired position, for example by means of magnets, removable parts, slides or undercuts. If necessary, the inserts can be provided by the prepreg. Depending on the nature of the insert, the constructive configuration of the component and the configuration of the pressing tool, the magnets, removable parts, slides or undercuts can be present in the top or bottom tool half.

If the inserts are introduced by means of removable parts, the inserts must be screwed onto the removable parts before the pressing operation. During demolding, the removable parts are initially removed from the tool together with the component, are unscrewed from the inserts and are replaced in the tool. Because of the low viscosity of the liquid matrix material starting component (that is to say the reactive monomer solution, in particular a lactam melt), it is necessary to ensure the adequate sealing of the removable parts, so that they are not “back-pressed” with the polymerizing matrix material starting component and as a result remain stuck in the tool. The preferred geometry of the seals is as O-rings. When selecting the sealing material, attention must be paid to its resistance to the matrix material starting component (that is to say preferably lactam).

If permanent magnets are used, account must be taken of the fact that a magnetic holder does not offer security against slipping of the insert during the pressing operation. In this case, too, the inserts must be placed on the permanent magnet in advance of the pressing operation.

If slides were to be used, these must be configured in such a way that they are capable of being removed from the thread, for example by being rotatable or reduced in size. In this case, too, the inserts must be positioned on the slide in advance of the pressing operation.

If undercuts are used to receive the inserts, these undercuts must be configured in such a way that a slight deformation is assured. In this case, too, the inserts must be introduced into the press tool in advance of the pressing operation.

Attention must be paid to the sealing of the inserts in all cases, in order to prevent the thread from being filled up by the free-flowing matrix material starting component.

In all cases, the inserts must be heated by the heated tool before the pressing operation is started, since an excessively low temperature (that is to say, for example, below 120° C.) compromises the polymerization of the matrix material starting component (that is to say a lactam melt). The pressing force used for this can lie in the range from 5 to 500 bar, although preferably in the range below 250 bar.

As already indicated above, the molten matrix material starting component heated in the press tool exhibits an extremely low viscosity, to which the press tool must be specially adapted. For this purpose, the press tool can exhibit, in the vertical direction of the tool, an already mentioned top tool half and a bottom tool half, which define the tool cavity in which the fiber semi-finished product can be loaded. The press tool is configured in such a way that, in the closed state, the top tool half is dipped into the bottom tool half and is adjusted at a distance from the bottom tool half by a vertical dipping edge gap. The dipping edge gap opens at the bottom into the tool cavity and at the top into a sealing gap, in particular a horizontal sealing gap, which is configured between the top and the bottom tool half. The sealing gap can preferably be divided into a throttle gap facing towards the dipping edge gap and a sealing zone having at least one sealing element, and in particular two sealing elements, surrounding the tool cavity. An overflow cavity can be configured in the bottom tool half between the inner, first sealing element and the outer, second sealing element. During the pressing operation in the heated press tool, the matrix material starting component melts in the fiber semi-finished product and fills the tool cavity including the negative mold for the force transmission structure. In addition, the molten matrix material starting component rises upwards in the dipping edge gap as far as the inner, first sealing element. It is possible in this way to guarantee that the tool cavity, including the negative mold for the force transmission structure, is filled completely.

The sealing concept mentioned above is of multi-step configuration and is specifically designed for a free-flowing matrix material starting component (referred to below as a lactam melt). In addition, an internal mold pressure inside the tool cavity can be increased with the multi-step sealing concept, which contributes to better filling of the cavity.

The lactam melt rises upwards in the course of the pressing operation as a result of the internal mold pressure inside the cavity. If surplus lactam melt is present, which can no longer be received in the available tool cavity, this will also rise upwards in the dipping edge gap. The lactam melt exiting from the dipping edge gap is initially strongly decelerated/throttled through the throttle gap, as a result of which the internal mold pressure increases. The internal mold pressure can be adjusted by the inner, first sealing element (preferably a peripheral O-ring seal) so that different seal diameters can be used. If the inner, first sealing element is adjusted in such a way that it makes no contact with the top tool half, the lactam melt exiting from the throttle gap will be throttled once more, although not completely held back. This collects subsequently in the flat and broad overflow cavity with a preferably peripheral, semi-round profile. The outer, second sealing element, which is likewise adjustable, is provided in order to ensure that no lactam melt is able to exit through the press tool at this point. However, its diameter must be selected so that it seals the press tool completely.

When adjusting the internal mold pressure by means of a different seal diameter, a constant quantity of lactam melt is dependent on the following: if the internal mold pressure is to be increased, the first sealing element can be adjusted in such a way that it seals completely. The lactam melt does not then come into the overflow cavity, and the tool cavity to be filled is altogether smaller. If, on the other hand, the internal mold pressure is to be reduced, the first sealing element can be of somewhat smaller configuration, so that it has only a throttling function and the lactam melt can flow away into the overflow cavity. The second sealing element must accordingly be of somewhat larger configuration, so that it then seals completely.

In order to achieve adequate fiber entrainment and fiber distribution in the negative mold for the force transmission structure in the course of the pressing operation, the solution viscosity of the lactam melt must be sufficiently high for the short fibers to be swept into the negative mold. A chemical thickening agent is mixed with the lactam for this purpose and is dissolved completely therein. The viscosity of the solution can be adjusted in relation to the proportion of the thickening agent to the total mass of the resulting solution. This proportion preferably lies in a range from 1 to 10% by weight, by means of which an increase in the viscosity of 5 mPas (normal lactam melt) to 200 to 2000 mPas can be achieved.

The advantageous embodiments and/or refinements of the invention explained above and/or described in the dependent claims can find an application individually or also in any desired combination with one another, except, for example, in cases of obvious dependencies or incompatible alternatives.

The invention and its advantageous embodiments and refinements as well as their advantages are explained in more detail below on the basis of drawings, in which:

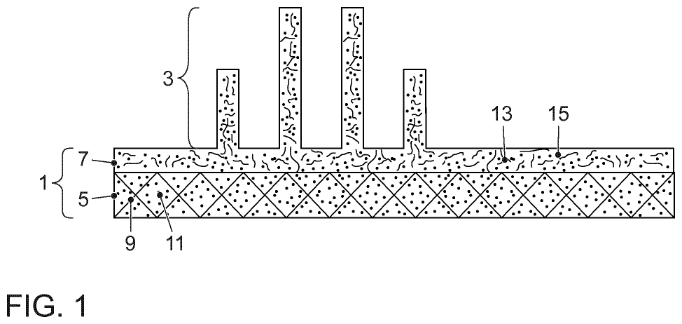

FIG. 1 depicts a finished, fiber reinforced plastic component in a laterally sectioned representation;

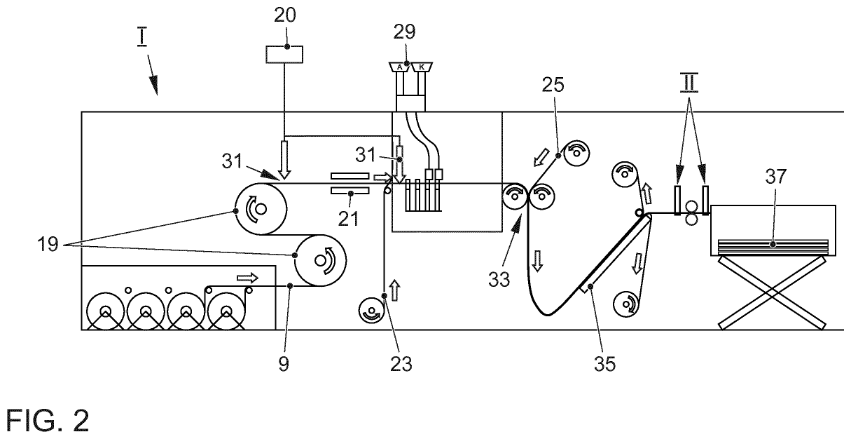

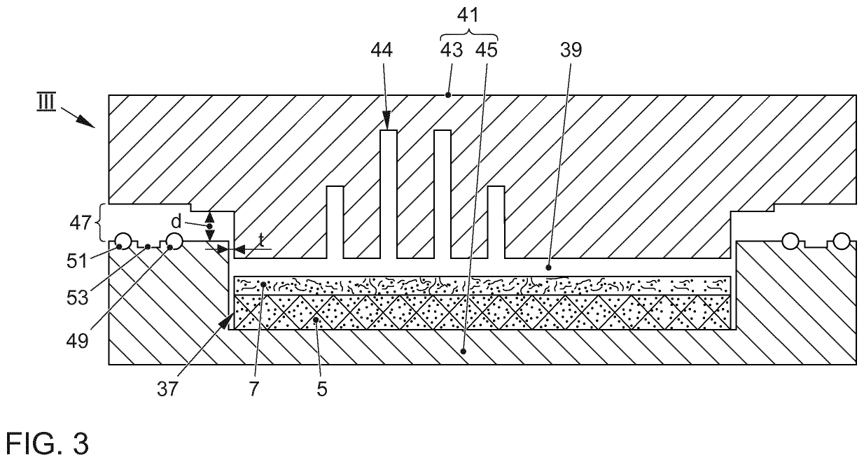

FIGS. 2 and 3 depict respectively process stations of a process arrangement for the production of the plastic component depicted in FIG. 1;

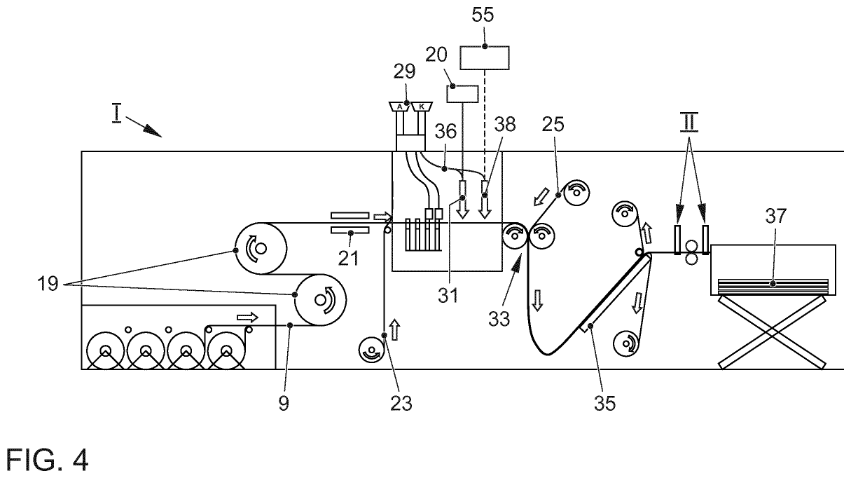

FIGS. 4 to 6 depict respectively views corresponding to FIG. 2 of modified process arrangements; and

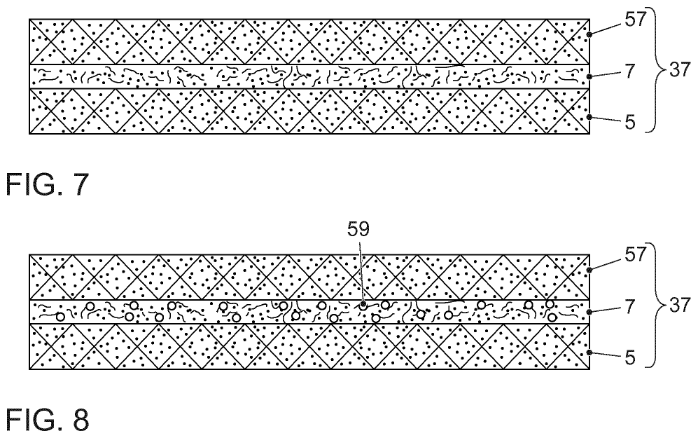

FIGS. 7 and 8 depict respectively a layer structure of a fiber reinforced textile fiber semi-finished product (known as prepregs) according to different variant embodiments.

Depicted in FIG. 1 is a fiber reinforced plastic component in a laterally sectioned representation, which has a two-dimensional basic body 1 with a rib structure 3 projecting therefrom. The basic body 1 is constructed in two layers from a support layer 5 and a short fiber layer 7 supported thereon. The support layer 5 in FIG. 1 has an endless fiber layer 9, for example, which is embedded in a polymer thermoplastic matrix material 11. The short fiber layer 7 has short fibers 13, which is likewise embedded in a polymerized thermoplastic matrix material 15. The thermoplastic matrix materials 11, 15 can be identical materials or different materials, depending on the production method. In FIG. 1, the rib structure 3 is constituted exclusively by the material of the short fiber layer 7. FIG. 1 and the following figures are also drawn with a view to providing a clear understanding of the invention. The figures are thus only highly simplified representations, which are not true to reality.

Described below on the basis of FIGS. 2 and 3 is a process arrangement, with which the plastic component depicted in FIG. 1 is produced. The process arrangement in FIG. 2 thus has a production station I, in which, for example, a still dry endless fiber layer 9 is conveyed over heating rollers 19 through an IR heating unit 21 and is deposited on a bottom support film 23, which runs between a bottom film unwinder and a bottom film rewinder. The endless fiber layer 9 deposited on the film 23 is heated to a temperature below a polymerization starting temperature of a matrix material starting component (referred to below as lactam), which contains lactam together with an activator, a catalyzer and, if necessary, with additives. The endless fiber layer 9 is saturated with molten lactam by means of a metering unit 29. Application points 31 are provided in a process direction between the heating roller 19 and the IR heating unit 21, as well as (as an alternative or in addition) between the IR heating unit and the metering unit 29. The dry short fibers 13 that are stored in a short fiber reservoir 20 are applied at the points of application 31 to the likewise still dry endless fiber layer 9, to be precise while forming a two-layer structure consisting of the endless fiber layer 9 and the short fiber layer 13. The two layers 9, 13 are saturated with the molten lactam jointly in an impregnation step by means of the metering unit 29. The two-layer structure saturated with lactam is then guided together with a further film 25 through a crushing calender 33 to a cooling section 35, in which the textile layer structure is cooled (that is to say consolidated). The consolidated textile layer structure is made up into individual, pre-impregnated textile fiber semi-finished products 37 in a following cutting station II.

The made-up fiber semi-finished products 37 are then transferred into a pressing station III depicted in FIG. 3 and into a tool cavity 39 of a heatable press tool 41. The press tool 41 has a top tool half 43 and a bottom tool half 45. The negative mold 44 for the rib structure 3 of the plastic component depicted in FIG. 1 is reproduced in the top tool half 43.

The press tool 41 is depicted only partially closed in FIG. 3. With the press tool 41 completely closed, the top tool half 43 is dipped into the bottom tool half 45. The two tool halves 43, 45 are separated from one another by a vertical dipping edge gap t. This opens at the bottom on the edge into the tool cavity 39 and at the top into a horizontal sealing gap 47, which is formed between the top and bottom tool halves 43, 45. The sealing gap 47 is divided in FIG. 3 into a throttle gap d facing towards the dipping edge gap t having a small flow cross-section and a two-step sealing zone facing away therefrom, which consists of an inner, first sealing element 49 and an outer, second sealing element 51. An overflow cavity 53 is configured in the bottom tool half 45 between the two peripheral sealing elements 49, 51. The sealing elements 49, 51 and the overflow cavity 53 can be arranged in the top tool half 43 or in the bottom tool half 45.

As is further evident from FIG. 3, the fiber semi-finished product 37 is loaded in the tool cavity 39 in such a way that its short fiber layer 7 faces towards the negative mold 44 for the rib structure 3 formed in the top tool half 43. Molding of the plastic component is then initiated, involving the building up of an internal mold pressure and the concurrent heating of the press tool 41.

Alternative arrangements of the production station I depicted in FIG. 2 are depicted in FIGS. 4 to 6. Depicted in FIG. 4 is a first metering unit 29, with which the still short fiber-free, dry endless fiber layer 9 is impregnated. A short fiber application point 31, at which dry short fibers 13 from the short fiber reservoir 20 are applied to the impregnated endless fiber layer 9, is provided downstream in the process direction. Also in FIG. 4, a connecting line 36 is led from the metering unit 29 to a matrix material application point 38, which is positioned after the short fiber application point 31 in the process direction. Also represented as an alternative in FIG. 4 is an additional metering unit 55, with which the molten matrix material starting component is conveyed independently from the first metering unit 29 to the matrix material application point 38, in order to impregnate the dry short fibers 13 of the short fiber layer 7 with the matrix material starting component. This also permits a different viscosity of the matrix material starting component to be achieved for the endless fiber-reinforced support layer (reference designation 5 in FIG. 1) and for the short fiber support layer 7.

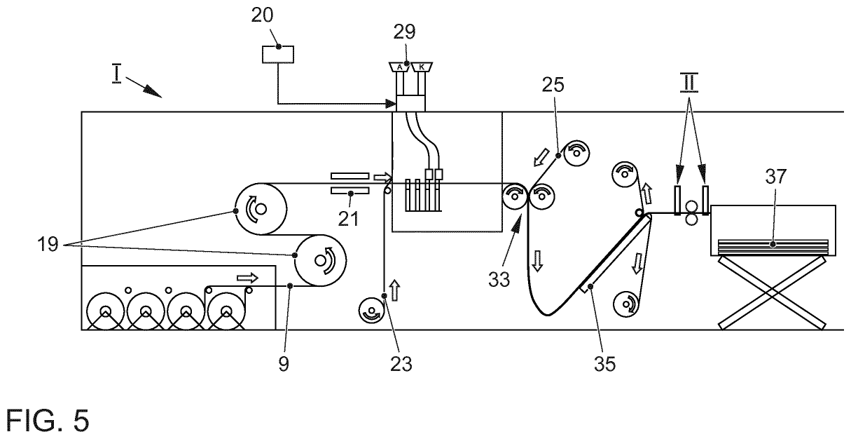

In FIG. 5, the short fiber reservoir 20 is connected directly to the metering unit 29. In this case, the short fibers 13 are not applied in a dry state to the endless fiber layer 9 at application points 31, but are mixed with the molten matrix material starting component in the metering unit 29. Both the impregnation of the endless fiber layer 9 and the application of the short fibers thus take place in a common process step during application of the matrix material starting component.

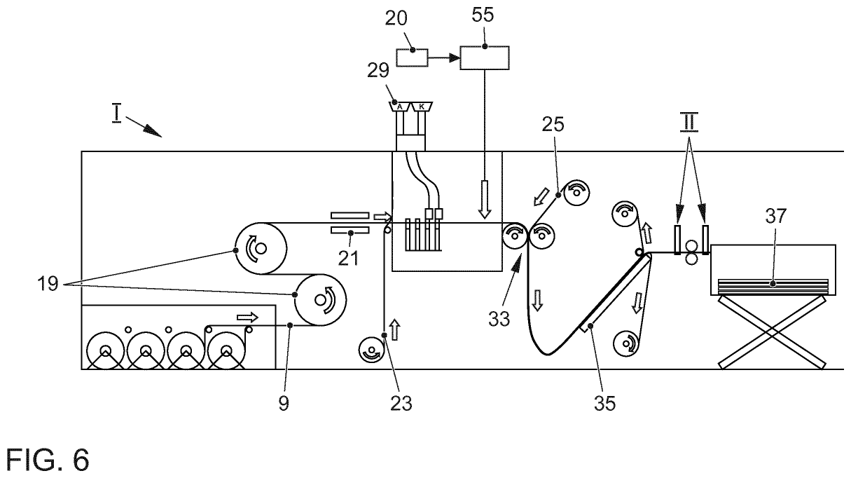

Two separate metering units 29, 55 are made available in FIG. 6, and also in FIG. 4. Impregnation of the endless fiber layer 9 with a short fiber-free matrix material starting component is effected by means of the first metering unit 29. The second metering unit 55 is connected to the short fiber reservoir 20, with the result that the short fibers 13 are mixed with the molten matrix material starting component in the metering unit 55. An application step then takes place, in which the matrix material starting component with the admixed short fibers 13 is applied to the already impregnated endless fiber layer 9. Here, too, as in FIG. 4, it is possible to achieve a different viscosity of the matrix material starting component for the endless fiber reinforced support layer (reference designation 5 in FIG. 1) and for the short fiber support layer 7.

An alternative layer structure of a plastic component according to a further illustrative embodiment is depicted in FIG. 7. Accordingly, a third fiber layer 57 is applied to the short fiber layer 7 so as to form a sandwich structure. The third fiber layer 57 can have an endless fiber reinforced structure, for example. In FIG. 8, furthermore, the middle short fiber layer 7 has a foam structure 59. The fiber semi-finished products 37 depicted in FIGS. 3, 7 and 8 need not be transferred to the press tool 41 depicted in FIG. 3, but can be transferred to any other heatable press tools or deep drawing tools and loaded there.

### LIST OF REFERENCE DESIGNATIONS

1 basic body
3 rib structure
5 support layer
7 short fiber layer
9 endless fiber layer
11 matrix material
13 short fibers
15 matrix material
19 heating roller
20 short fiber reservoir
21 IR heating unit
23 bottom film
25 top film
29 metering unit
31 application points
33 crushing calender
35 cooling section
36 connecting line
37 fiber semi-finished product
38 lactam application point
39 tool cavity
41 press tool
43 top tool half
44 negative mold of rib structure 3
45 bottom tool half
47 sealing gap
49 inner sealing element
51 outer sealing element
53 overflow cavity
55 metering unit
57 third fiber layer
59 foam structure
I production station
II making-up station
III pressing station
t dipping edge gap
d sealing gap

1-15. (canceled)

16. A method for producing a fiber-reinforced plastic component, the method comprising the following steps:
supplying an at least two-layer or multi-layer textile structure formed of a support layer and a short fiber layer applied to the support layer, the short fiber layer including short fibers saturated with a not yet polymerized, reactive thermoplastic starting component of a matrix material;
processing the textile structure into a fiber-reinforced, textile fiber semi-finished product; and
pressing or deep drawing the fiber-reinforced, textile fiber semi-finished product into a mold for the fiber-reinforced plastic component to be produced with concurrent heating of the fiber reinforced, textile semi-finished product to a temperature above a polymerization starting temperature.

17. The method according to claim 16, which further comprises providing the support layer with at least one endless fiber layer being saturated in an impregnation step with a reactive, thermoplastic starting component of a matrix material.

18. The method according to claim 17, which further comprises:
supplying the short fibers as an out-of-process, fresh fiber material in a dry state with a predefined fiber length;
applying the dry short fibers to the support layer with the support layer being in a dry state; and
carrying out the saturation of both the support layer and the dry short fibers jointly in the impregnation step.

19. The method according to claim 18, which further comprises manually scattering and applying the dry short fibers to the already impregnated support layer, and using a surplus material of the matrix material of the support layer as a matrix material for the applied short fibers.

20. The method according to claim 19, which further comprises carrying out the saturation of the short fibers applied to the impregnated support layer in a further impregnation step situated downstream in process engineering at a matrix material application point positioned after a short fiber application point in a process direction, and supplying the matrix material application point with matrix material from a metering unit or from a separate metering unit.

21. The method according to claim 16, which further comprises admixing the short fibers being still in a dry state to the matrix material starting component in a liquid state in a metering unit and applying the short fibers in an impregnation step together with the matrix material starting component, for concurrently carrying out both a pressure saturation of the support layer and the application of short fibers to the support layer.

22. The method according to claim 16, which further comprises saturating the support layer with a short fiber matrix material starting component in an impregnation step, and then carrying out an application process step by applying the matrix material starting component to the support layer together with the short fibers admixed in a metering unit.

23. The method according to claim 16, which further comprises applying a third fiber layer to the two-layer textile structure formed of the support layer and the short-fiber layer while forming a sandwich structure, and additionally foaming the short fiber layer as a middle layer.

24. The method according to claim 16, which further comprises applying a laminating film on one or both sides of the at least two-layer textile structure as at least one of a bottom layer or a top layer, and using the laminating film to perform a surface function and a protective function.

25. The method according to claim 16, which further comprises:
providing the fiber reinforced plastic component as a two-dimensional support component having a short fiber reinforced force transmission structure protruding therefrom by:
pressing the structure in a press tool including a tool half forming a negative mold for the force transmission structure;
inserting the fiber semi-finished product into a tool cavity with the short fiber layer of the force transmission structure facing towards the negative mold formed in the tool half; and
placing the tool half on top in a vertical direction of the press tool, causing the matrix material starting component in a heated molten state to be pressed upwards into the negative mold of the top tool half.

26. The method according to claim 25, which further comprises:
using the tool half of the press tool as a top tool half and providing the press tool with a bottom tool half in the vertical direction of the tool, defining the tool cavity between the tool halves into which the fiber semi-finished product can be loaded; and
with the press tool closed, separating the top tool half from the bottom tool half by a vertical dipping edge gap opening downwards into the tool cavity and upwards into a horizontal sealing gap provided between the top and bottom tool halves.

27. The method according to claim 26, which further comprises dividing the sealing gap into a throttle gap facing towards the dipping edge gap and a sealing zone facing away from the dipping edge gap and having at least one or two sealing elements surrounding the tool cavity.

28. The method according to claim 27, which further comprises providing the sealing elements as an inner first sealing element and an outer second sealing element, and providing an overflow cavity in the bottom or top tool half between the first and second sealing elements.

29. A process arrangement for producing a fiber-reinforced plastic component, the process arrangement comprising:
a production station for supplying and processing at least one fiber-reinforced fiber semi-finished product having a support layer and a short fiber layer applied on the support layer, the short fiber layer having short fibers being saturated with a not yet polymerized, reactive thermoplastic starting component of a matrix material; and
a pressing station or a deep drawing station for heating the fiber semi-finished product to a temperature above a polymerization starting temperature and for at least one of concurrently pressing or deep drawing the fiber semi-finished product into a mold for the plastic component to be produced.

30. A fiber-reinforced plastic component, comprising:
a fiber-reinforced, textile fiber semi-finished product including an at least two-layer or multi-layer textile structure formed of a support layer and a short fiber layer applied to the support layer, the short fiber layer including short fibers saturated with a not yet polymerized, reactive thermoplastic starting component of a matrix material;
the fiber-reinforced, textile fiber semi-finished product having characteristics of having been pressed or deep drawn into a mold for the fiber-reinforced plastic component with concurrent heating of the fiber reinforced, textile semi-finished product to a temperature above a polymerization starting temperature.
